(19) United States
(12) Patent Application Publication
(10) Pub. No.: US 2015/0247386 A1
(43) Pub. Date: Sep. 3, 2015

(54) METHOD AND DEVICE FOR COLLECTING A LIGHT UNDERWATER FLUID SUCH AS FRESH WATER OR HYDROCARBONS

(71) Applicant: NYMPHEA ENVIRONNEMENT, Cassis cedex (FR)

(72) Inventors: Thierry Gilles Carlin, Toulon (FR); Pierre Jacques Etienne Becker, Bras (FR)

(21) Appl. No.: 14/429,712

(22) PCT Filed: Sep. 19, 2013
(86) PCT No.: PCT/FR2013/000247

§ 371 Date: Mar. 19, 2015

(30) Foreign Application Priority Data
Sep. 21, 2012 (FR) 1202512

(51) Int. Cl. E21B 43/01; C02F 1/00; E21B 43/36; B01D 17/02

(52) U.S. Cl. CPC E21B 43/0122; B01D 17/0211; B01D 17/0214; C02F 1/008; E21B 43/36; C02F 2103/08

(57) ABSTRACT

The invention relates in particular to a device for undersea collection of a light fluid the device comprising:
a first tank that is provided with a first opening and a second opening;
a second tank covering the first opening, surrounding a portion of the first tank, and provided with a third opening putting the second tank, into communication with the medium surrounding the device;
connection means connecting together the first and second tanks:
a first pipe opening out into the first tank in order to provide density transport of a phase of the fluid to the surface;
a structure for guiding and introducing the fluid into the first tank, which structure extends inside the first tank and separates a first portion of the first tank in which the second opening is provided from a second portion of the first tank in which the open end of the first pipe extends; and
a structure for collecting the fluid, which structure extends outside the first tank, is secured to the first tank, and surrounds the second opening.

### TECHNICAL FIELD

The present invention relates to a method of collecting one or more light undersea fluids, in particular an undersea jet containing a plurality of phases of density less than that of sea water, and to a collector device for performing such a method.

The invention applies in particular to collecting hydrocarbons escaping from an undersea pipe or well that is damaged and situated at great depth, and also to collecting from an undersea spring of fresh water including or mixed with a gaseous phase.

Unless stated explicitly or implicitly to the contrary, in the present application, the qualifiers “light” and “heavy” are used relative to the properties of sea water; thus the term “light fluid” designates a fluid of density that is less than that of sea water.

### STATE OF THE ART

Patent EP 1 644 589 describes a method and a device for capturing fresh water corning from an undersea spring.

The device has a first pipe with a bottom end surrounding the spring in leaktight manner, a second pipe of diameter smaller than the diameter of the top portion of the first pipe, and an open-bottomed tank covering the top end of the first pipe and imprisoning air.

The bottom end of the second pipe is immersed inside the top portion of the first pipe, and the top end of the second pipe is situated above the water-air interface inside the tank so as to avoid polluting the fresh water with sea water, and so as to limit the hydraulic overload on the spring.

When the fresh water produced by the spring contains a gaseous phase, which may be dissolved in a liquid phase, such a device does not enable the gaseous phase and the liquid phase to be separated, both phases being collected and entrained together in the second pipe.

Numerous devices have also been proposed for collecting hydrocarbons escaping from a damaged, undersea pipe or well.

Patent application US 2012/0125623A1 describes a hydrocarbon collector designed to be connected to a well blow-out preventer (BOP).

As described in particular in the document “A model for simulating deep-water oil and gas blow-outs—Part 1: theory and model formulation”, by Li Zheng et al., Journal of Hydraulic Research, Vol. 41, No. 4, 2002, pp. 339-351, an undersea, jet of hydrocarbons forms a plume as it rises and mixes with sea water, and then forms a “cloud” of droplets.

When a jet of hydrocarbons escapes into sea water at great depths, the low temperature and high pressure of sea water encourage the formation of “hydrates”, thereby making it difficult to collect the jet.

Patent application US 2012/0155964A1 describes a device for collecting a hydrocarbon plume at great depths, which device comprises a collector bell placed over the plume, a separator tank arranged close to the surface, and a riser column connecting the bell to the tank.

A pipe connecting the tank to the atmosphere allows gas contained in the tank to escape, while the liquid phase is pumped and removed from the tank via another pipe so as to keep the tank and the riser column in suction, thereby causing the plume of hydrocarbons mixed with sea water to rise in the riser column.

In order to limit the formation of hydrates, the bell and the riser column are thermally insulated and initially filled with nitrogen and/or helium.

A drawback of such a collector system is that it collects a large quantity of sea water mixed with the hydrocarbons and giving rise to the formation of hydrates.

Another drawback of that system is that it requires a riser column of large diameter and great length and that can withstand suction and possibly also pressure.

Another drawback of that system is that it requires a large capacity pump.

Documents U.S. Pat. No. 4,318,442 and WO 81/01310 describe devices that are arranged on the sea bottom in order to be placed over a damaged well head.

U.S. Pat. No. 4,318,442 describes apparatus comprising a ballasted vessel having a top opening, a closure valve for the opening, a gas transport pipe enabling a gaseous plenum to be maintained, in the vessel, a liquid transport pipe opening under the gaseous plenum, and vents situated under the liquid outlet in order to compensate for variations in the leakage flow rate from the well and outlet flow rates of liquid and gaseous fluids.

The vessel thus defines a cavity that is maintained in pressure equilibrium with the sea water surrounding the apparatus, and the liquid hydrocarbons rise in the liquid transport pipe under the gravity (or density) effect, i.e. because of the density of liquid hydrocarbons being lower than the density of the surrounding sea water.

In order to avoid hydrocarbons escaping through the vents, a pump assists in transporting liquid hydrocarbons in the liquid transport pipe so as to entrain sea water.

WO 81/01310 describes a hydrocarbon collector apparatus having a column for separating liquid and gaseous hydrocarbon phases, and a pump serving to discharge the liquid phase.

Such systems are not suitable for collecting hydrocarbons from a depth greater than a few hundreds of meters where the low temperature of the sea water mixed with the hydrocarbons gives rise to the formation of hydrates that are liable to block the liquid transport pipe and/or the collector apparatus.

### SUMMARY OF THE INVENTION

An object of the invention is to propose a device for collecting an undersea fluid or a mixture of undersea fluids, in particular from an undersea spring or other source containing one or more fluid phases, which device should be simple to implement.

An object of the invention is to provide a device for collecting an undersea fluid or a mixture of undersea fluids, in particular from an undersea spring or other source containing one or more fluid phases, which device is adapted to use at great depths, in particular depths of not less than 500 meters (m) or 1000 m, e.g. at depths situated in a range going from approximately 1000 m to approximately 2000 m or 3000 m.

An object of the invention is to provide a method of collecting a light undersea fluid or a mixture of light undersea fluids, and a collector device for performing such a method, which device and method are improved and/or remedy, at least in part, the shortcomings or drawbacks of presently-known methods and devices for collecting undersea fluids.

Unless indicated explicitly or implicitly to the contrary, the terms “enclosure(s)”, “vessel(s)”, and “tank(s)” should be considered as synonyms in the present application, and they are therefore used interchangeably.

Unless indicated explicitly or implicitly to the contrary in the present application, the noun “fluid” is used to designate a fluid in the liquid and/or gaseous phase, or a mud comprising a liquid phase and a solid phase, or a mixture of fluids or of gaseous, liquid, and/or solid phases.

According to an aspect of the invention, there is provided a device for undersea collection of a fluid of density that is less than the density of sea water, which device comprises:

a first tank for receiving the fluid, which tank is provided with a first opening and a second opening;

a second tank covering the first opening, surrounding a portion of the first tank, and provided with a third opening putting the second tank into communication with the medium surrounding the device;

connection means connecting together the first and second tanks;

a first pipe opening out into the first tank in order to provide density transport of at least a first phase of the fluid to the surface;

a structure for guiding and introducing the fluid in the first tank, which structure extends inside the first tank and separates a first portion of the first tank in which the second opening is provided from a second portion of the first tank in which the open end of the first pipe extends; and

a structure for collecting the fluid, which structure extends outside the first tank, is secured to the first tank, and surrounds the second opening.

The device may have a second pipe opening out into the second tank for density transport of at least one second phase of the fluid to the surface.

The fluid collector structure, which may be made at least in part out of plastics material or out of elastomer, is preferably flexible or deployable so as to pass from a gathered configuration suitable for moving and installing the device under water, to a deployed configuration adapted to collecting the fluid.

The fluid collector structure may be constituted essentially by a jacket of tubular or frustoconical shape (in the form of a skirt); the surface of the structure may be undulating and/or folded.

When the collector structure is deployed, the volume of the space it defines is preferably not less than the volume of the first tank and/or than the volume of the cavity defined by the first and second tanks.

The device may include a third pipe including (or forming) said structure for guiding and introducing the fluid, and also said structure for collecting the fluid; and under such circumstances in particular a free end of the third pipe for introducing the fluid into the collector and separator device may be provided with a connection device appropriate for the structure (in particular a pipe or a BOP) from which the fluid for collection is escaping, e.g. a device as described in above-mentioned patent, application US 2012/0155965A1.

The invention applies in particular to collecting a liquid hydrocarbon, a mixture of liquid and gaseous hydrocarbons, a mixture of gaseous hydrocarbon(s) and a mud comprising one or more liquid hydrocarbons mixed, with hydrates, and also to collecting fresh water mixed with one or more gases that may be dissolved in the fresh water.

The invention makes it possible to separate the phases of the collected fluid, or mixture of fluids, inside the vessels.

The invention makes it possible to absorb variations in flow rate, in pressure, and/or in the composition of the fluid/mixture admitted via the inlet of the device, and/or variations in the discharge flow rate of the extracted phase(s) of the fluid/mixture, which variations can give rise to variations in the levels of the respective interfaces between the first and second phases, i.e. inside the first vessel, and between the second phase and sea water, i.e. in the space extending between the first and second vessels and in communication with the undersea medium surrounding the device.

The invention makes it possible to transport the phases separated by the device in pipes that are maintained substantially in pressure equilibrium with the surrounding undersea medium, thus making it possible to use pipes presenting little mechanical strength and/or pipes that are flexible.

Since the enclosures/vessels of the device are also maintained substantially in pressure equilibrium with the undersea environment, they may also present little mechanical strength and/or a structure that is flexible.

The pipes and/or the vessels may in particular include a deployable structure that is made of a plastics material or of elastomer, and in particular a structure that is “inflatable”, having a double wall suitable for containing sea water.

Such flexible structures can contribute to limiting the adhesion of hydrates to their respective surfaces, and consequently to limiting any risk of the device becoming clogged.

The invention makes it possible to limit the formation of hydrates by avoiding, or at least limiting, contact between the liquid hydrocarbons and sea water, and by limiting the contact area between gaseous hydrocarbons and sea water.

In another aspect of the invention, there is provided a method of collecting an undersea fluid comprising at least a first phase of density less than the density of sea water, and where applicable at least one second phase of density less than that of sea water and less than that of the first phase, the method comprising the steps of:

causing the fluid to be introduced into a cavity communicating with the undersea medium in such a manner that the cavity is maintained in pressure equilibrium with the medium, the cavity being defined by two tanks: i) a first tank having a first opening and a second opening; and ii) a second tank covering the first opening, surrounding at least a portion of the first tank, connected to the first tank and in communication therewith, and provided with a third opening in communication with the undersea medium; transporting the fluid into a collector structure that extends outside the first tank, that is secured to the first tank, and that surrounds the second opening, and guiding the fluid by means of a guide structure that extends inside the first tank and that separates a first portion of the first tank in which the second opening is provided from a second portion of the first tank into which there opens out the open end of a first pipe opening out into the first tank, by enhancing the flow of the first phase in the first tank, and where applicable by enhancing separation of the phases in the cavity and the flow of the second phase in the second tank; and

recovering the first phase flowing (rising) by density difference in the first pipe, and, where applicable, recovering the second phase flowing (rising) by density difference in a second pipe opening out into the second tank.

In embodiments of the invention:

the device may include a fourth pipe opening out into the second tank and fitted with a sectioning (or closing) member such as a valve, this pipe serving to introduce a “rinsing” fluid, or “flushing” fluid, used for discharging (expelling) at least the portion of the sea water contained in the device prior to introducing the fluid for collection into the tank;

under such circumstances, it is possible to use a rinsing fluid in the form of a liquid or a gas and of density (i.e. mass per unit volume) that may be less than the density of the lowest density phase of the fluid for collection; for example it is possible to use nitrogen;

the rinsing fluid may be stored in, and come from, a third tank under pressure that is connected to the second tank via the fourth pipe;

at least a portion of the wall of the second tank, in particular the portion of this wall that extends around the first tank, may include thermal insulation so as to limit cooling of the phases of the fluid for collection, resulting from the sea water surrounding the collector device; for the same purpose, the first and/or second pipe may also include thermal insulation;

by way of example, the first pipe may be arranged (in particular dimensioned) so as to facilitate a flow of the first phase in the pipe at a mean speed lying in a range going from about 0.001 (10⁻³) meters per second (m/s) to about ten (10) m/s;

by way of example, the second pipe may be arranged (in particular dimensioned) so as to facilitate a flow of the second phase in the pipe at a mean speed lying in a range going from about 0.001 (10⁻³) m/s to about ten (10) m/s;

the first vessel may be arranged (in particular dimensioned) to provide temporary storage of the first phase therein; for this purpose, the capacity of the first tank may for example be not less than the quantity of the first phase of the mixture that is collected in a duration lying in the range going from about 0.1 (10⁻¹) seconds (s) to about one hundred (10²) s;

the second vessel may be arranged (in particular dimensioned) so as to provide temporary storage of the second phase therein; for this purpose, the capacity of the second tank may for example be not less than the quantity of the second phase of the mixture that is collected in a duration situated in a range going from about 0.1 (10⁻¹) s to about one hundred (10²) s;

at least one of the first and second tanks, which are contained at least in part one within the other, may present the general shape of a body of revolution, in particular a shape that is substantially cylindrical or the shape of a spherical cap; when both tanks are in the form of surfaces of revolution, the respective axes of revolution of those surfaces may substantially coincide;

at least one of the first, second, and third pipes may be fitted with at least one sectioning (or closure) member such as a valve or a shutter;

in particular, the device may include a shutter arranged at or in the vicinity of the inlet of the second pipe, the shutter having a movable member, such as a bead or a ball, of density presenting a value intermediate between the density of the first phase of the mixture and the density of the second phase of the mixture, such that the movable member can float on the first phase and prevent the first phase being introduced into the second pipe;

the collector device may include connection members for providing a rigid, or relatively undeformable connection between the first and second vessels/tanks;

the collector device may include means for positioning the tanks so as to hold the first and second vessels/tanks in the proximity of the place or the structure from which the mixture for collecting is escaping; these positioning means may for example comprise cables fastened to the sea bottom by anchors or by deadweights resting on the bottom;

the collector device may include phase separator means, in particular deflector or separator walls, that are arranged in the first vessel/tank in particular, in order to enhance mutual separation between the first and second phases inside the first and second vessels so as to avoid or limit passage of the second phase into the first pipe, and so as to avoid or limit passage of the first phase into the second pipe;

the collector device may comprise (at least) two separator modules providing phase separation in pressure equilibrium with the surrounding undersea medium, which modules are connected together by at least one rising column; and

the method of the invention may include the following operations:
immersing a collector device in the proximity of a jet or a source of fluid to be collected;
stably positioning the collector device relative to the structure from which the fluid for collection is escaping by anchoring it to the sea bottom and/or by establishing mechanical connections between the collector device and the structure;
introducing a rinsing fluid in the first and second tanks in order to discharge the sea water; and
deploying the collector structure around the structure from which the fluid for collection is escaping.

Other aspects, characteristics, and advantages of the invention appear from the following description, which refers to the accompanying figures and relates to embodiments of the invention that are preferred and without any limiting character.

### BRIEF DESCRIPTION OF THE FIGURES

FIG. 1 is a diagrammatic longitudinal section view of a device for collecting a light undersea fluid in an embodiment of the invention.

FIGS. 2 to 4 are diagrammatic longitudinal section views showing steps of a method of collecting a multiphase fluid with the help of the device shown in FIG. 1:

FIG. 2 corresponds to a step of immersing and positioning the collector device close to the structure from which the fluid for collecting is escaping;

FIG. 3 corresponds to a step of rinsing the collector device with a fluid introduced into the top portion of the second vessel; and

FIG. 4 corresponds to a step of separating the phases of the fluid as collected by the collector device connected to the structure from which the fluid is escaping.

FIG. 5 is a diagrammatic longitudinal section view of a device for collecting an undersea fluid in another embodiment of the invention.

FIG. 6 is a diagrammatic cross-section view of the collector device shown in FIG. 5, being a view on line VI-VI of FIG. 5.

FIG. 7 is a diagram showing a collector device in another embodiment that has two separator modules of the kind shown in FIGS. 1 and 5.

FIG. 8 is a diagrammatic longitudinal section view of a device for collecting an undersea fluid in another embodiment of the invention.

### DETAILED DESCRIPTION OF THE INVENTION

Unless specified explicitly or implicitly to the contrary, elements or members that are structurally or functionally identical or similar are designated in the various figures by references that are identical.

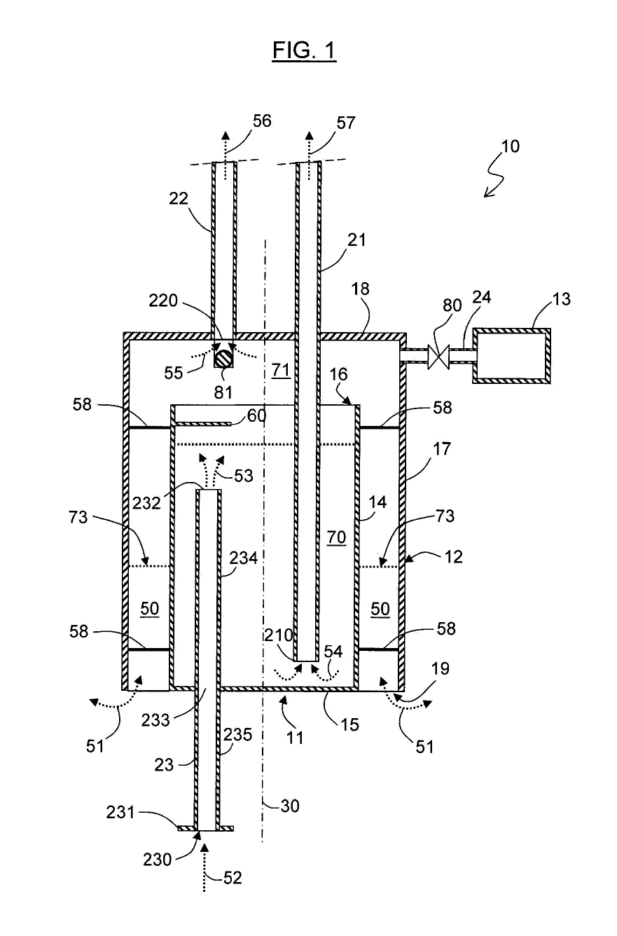

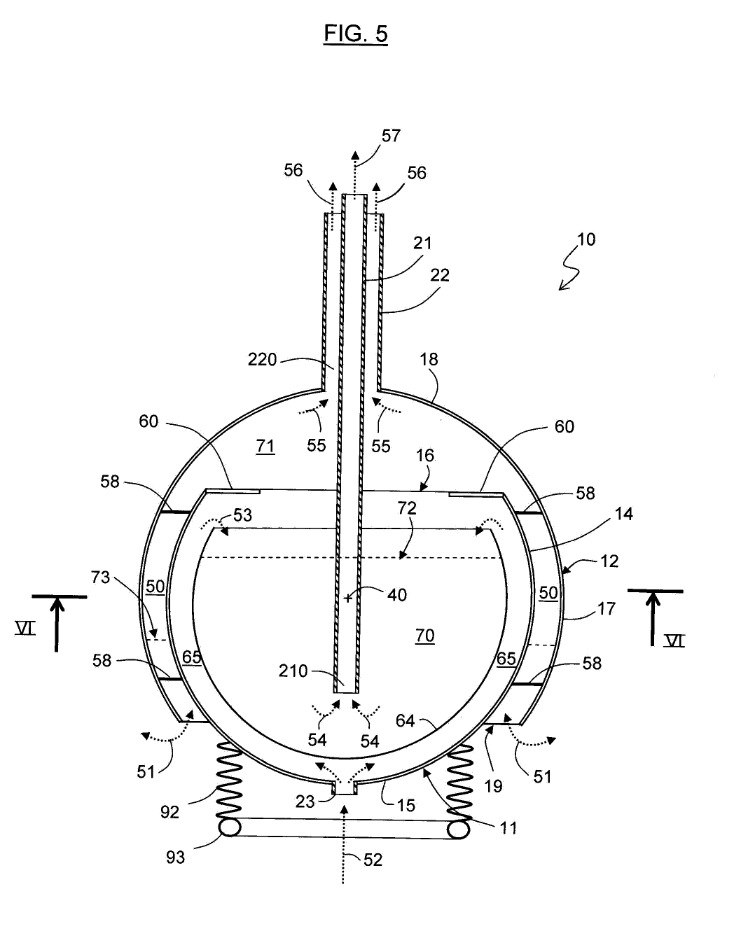

With reference to FIGS. 1 and 5 in particular, the collector device 10 is constituted essentially by two open vessels or tanks 11, 12, two or three pipes 21 to 23 leading into the tanks, and a collector structure extending under the first tank 11.

In the embodiment that corresponds to FIGS. 1 to 4 and 7, the first tank 11 has a side wall 14 of cylindrical shape extending about an axis 30 of revolution, and a bottom wall 15 closing a first longitudinal end of the wall 14, which end wall 15 is pierced by an orifice 233 for passing the collected fluid.

The second longitudinal end 16 of the wall 14 is not closed and forms a top opening for the tank 11.

In this embodiment, the second tank 12 has a side wall 17 of cylindrical shape extending about the same axis 30 of revolution, and an end wall 18 closing a first longitudinal end of the wall 17.

The second longitudinal end 19 of the wall 17 is not closed and forms a bottom opening for the tank 12.

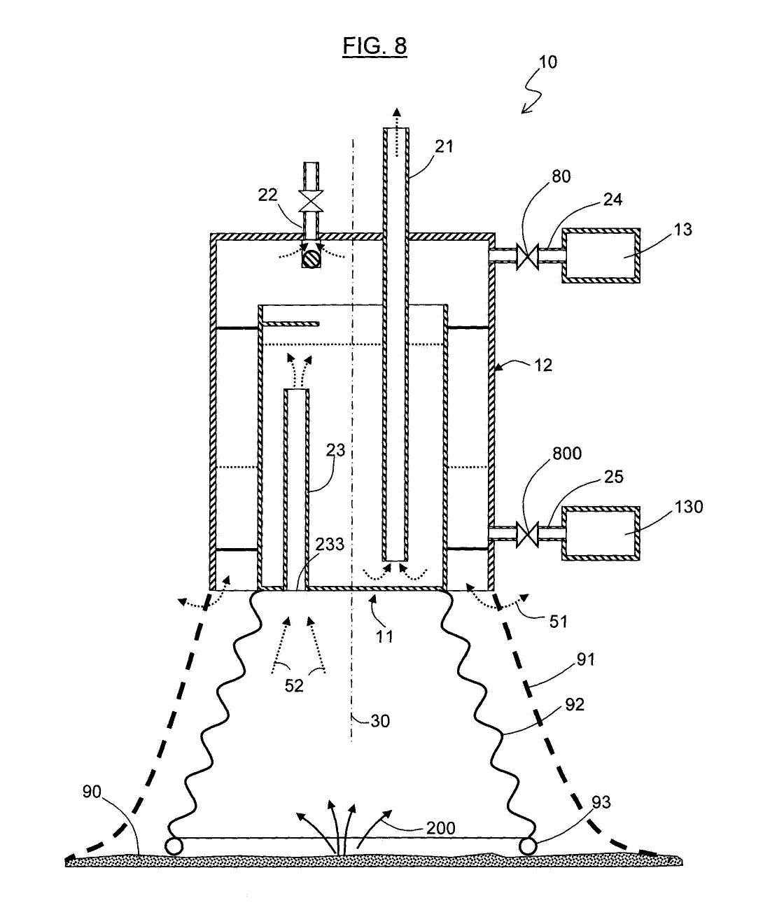

It can be seen in FIGS. 1 and 8 in particular that the end wall 15 of the first tank 11 extends substantially in the same plane as the opening 19 of the second tank, such that the first tank 11 lies substantially completely inside the cylindrical cavity defined by the second tank 12.

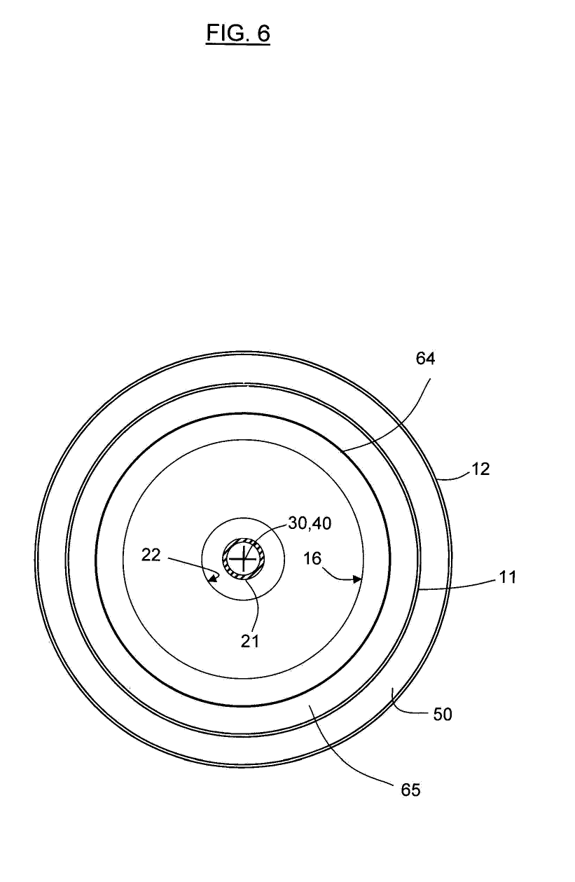

In contrast, in the embodiment corresponding to FIGS. 5 and 6, the first tank 11 extends in part only inside the cavity that is defined by the second tank 12 and that has the shape of a portion of a sphere.

In this embodiment, each of the first and second tanks 11 and 12 has a double wall in the form of a portion of a sphere extending about the same axis of revolution 30 and about the same center 40.

In the embodiments shown, the tanks 11 and 12 extend about a common axis 30.

In the embodiments shown, the top opening 16 of the first tank 11 faces the end wall 18 of the second tank 12, while the side wall 17 and the opening 19 of the second tank 12 extend around the first tank, at a distance therefrom, so as to co-operate with the side wall 14 of the first tank 11 to define a peripheral space 50.

This peripheral space 50 is annular in shape in the embodiment of FIGS. 1 to 4 and 8, and toroidal in shape in the embodiment of FIGS. 5 and 6, and it is open to (in communication with) the medium in which the device 10 is placed via the bottom opening 19 of the tank 12, and it is open to (in communication with) the cavity defined by the tank 11 at its top end surrounding the top opening 16 of the tank 11.

The peripheral space 50 thus enables sea water to flow 51 into or out from this space via the opening 19.

As shown in FIGS. 1 and 5 in particular, the vessels 11 and 12 are rigidly connected together via bars 58 connecting together the respective side walls 14 and 17 of the vessels 11 and 12 and extending across the peripheral space 50, but without closing it.

In the embodiment shown in FIGS. 1 to 4, the collector device 10 has a third pipe 23 that extends through the opening 233 in the end wall 15 of the tank 11 and that is open at its bottom end 230 extending outside the tank 11 so as to allow the mixture for collecting to be introduced 52 into the device 10.

The third pipe 23 is also open at its top (inside) end 232 extending inside the tank 11 so as to allow the mixture it is conveying to be introduced 53 into the device 10.

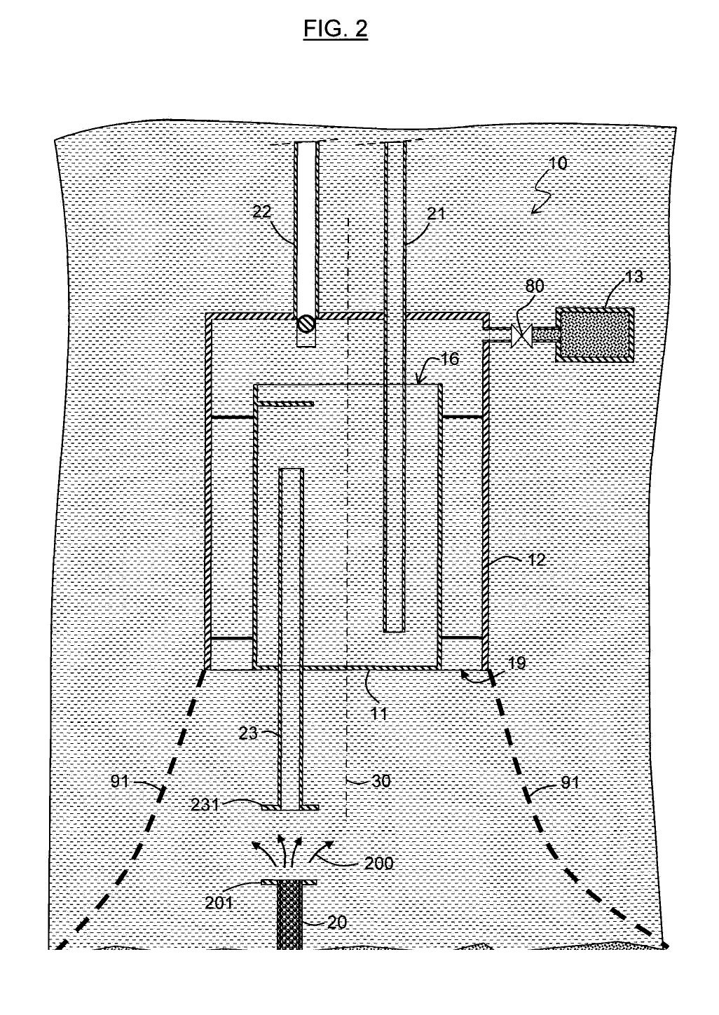

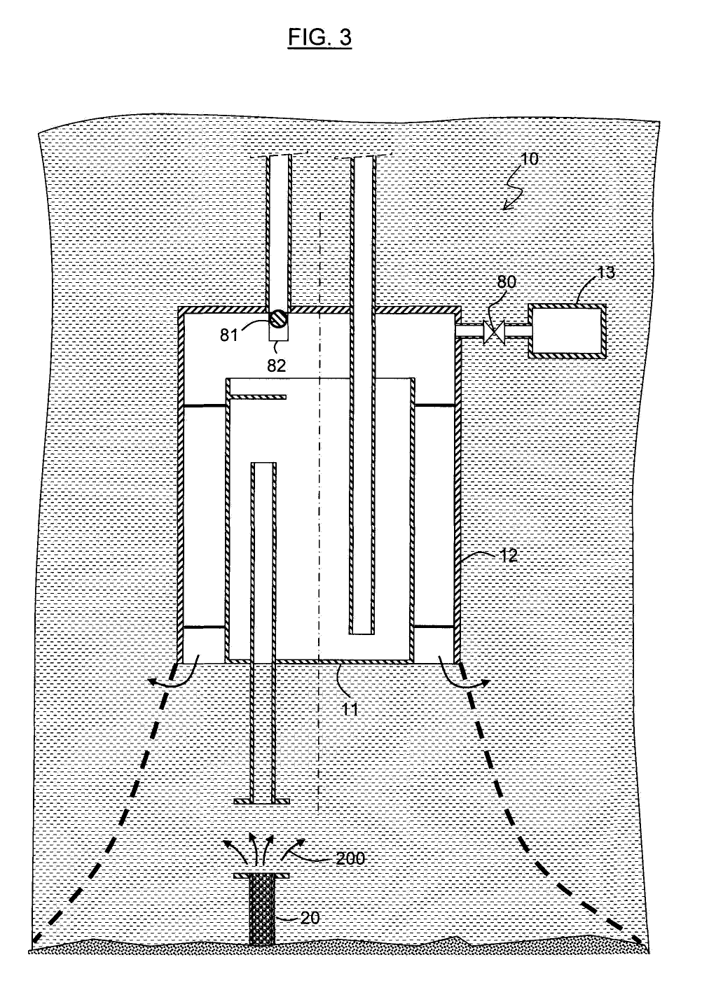

In FIGS. 1 to 4, it can be seen that the bottom (outside) end 230 of the pipe 23 is fitted with a connection member 231 appropriate for connecting to the structure 20 from which the fluid/mixture for collection is escaping (cf. arrows 200 in FIGS. 2 and 3).

This connection member 231 is represented diagrammatically in the form of a flange matching a complementary flange 201 fitted to the pipe 20, but it could take on various other forms.

In the embodiment shown in FIGS. 1 to 4, the top portion 234 of the third pipe 23 extending inside the tank 11 forms a structure for guiding and introducing fluid into the tank, while the bottom portion 235 of the third pipe 23 extending outside the tank 11 forms a structure for collecting the fluid.

In the embodiment shown in FIG. 8, the third pipe 23 extends in full inside the tank 11 and forms the structure for guiding and introducing the fluid into the tank, while the structure for collecting the fluid comprises a jacket 92 that extends under the first tank 11 to which it is secured, and that surrounds the second opening 233 that is provided in the bottom wall of the tank 11.

The fluid collector jacket 92 may comprise a layer of plastics material or of elastomer, together with a reinforcing structure such as a metal wire structure given a helical shape and extending around the general axis of symmetry 30 of the device.

Such a collector structure can thus pass from a gathered configuration adapted to moving and installing the device under water, as shown in FIG. 5, to a deployed configuration adapted to collecting the fluid, as shown in FIG. 8.

In the embodiment shown in FIG. 5, the structure for guiding and introducing the fluid into the tank 11 is constituted essentially by the wall 64.

In the embodiments shown, the device 10 has a first pipe 21 that extends through the end wall 18 of the tank 12, and that is open at its bottom (inside) end 210 extending inside the tank 11 in order to enable the denser phase of the collected mixture to be introduced 54 into the pipe 21, i.e. the first phase that has flowed into the tank 11 and possibly accumulated therein.

The pipe 21 forms, or is extended by, a riser column that may extend as far as the surface of the sea and that serves to provide gravity transport for the first phase coming from the first tank.

In the embodiments shown in FIGS. 1 to 7, the device 10 has a second pipe 22 that also extends through the end wall 18 of the tank 12 and that is open at its bottom end 220 whereby it opens out to the inside of the tank 12 above the tank 11 in order to enable the lighter phase of the collected mixture to be introduced 55 into the duct 22, which phase is separated from the mixture by gravity in the tank 12 and possibly accumulates therein.

The pipe 22 forms, or is extended by, a riser column that may extend as far as the surface 94 of the sea and that serves to provide gravity transport for the second phase coming from the second tank.

In contrast, in the embodiment shown in FIG. 8, the collector device 10 has only an “embryo” pipe 22 that is fitted with a valve opening out into the undersea medium so as to act as a vent in order to discharge any excess of the phase that accumulates in the plenum of the bell-shaped tank 12.

In FIG. 1, it can be seen that the first tank has a wall 60 extending over the outlet orifice 232 of the pipe 23 and crossing the line of the pipe, so that the wall 60 can deflect a jet 53 of collected mixture leaving the pipe 23, thereby causing or facilitating separation of the phases in the mixture; the same applies to the flow 53 of collected fluid leaving the peripheral passage 65 in FIG. 5.

In the embodiment of FIGS. 5 and 6, the first tank has a deflector wall 64 in the form of a portion of a spherical cap of center 40 that coincides substantially with the center of the walls 14, 15, 17, and 18 of the tanks 11 and 12.

Thus, inside the tank 11, the walls 14, 15, and 64 define a space or passage 65 in the form of a thick spherical sheet or bowl, with the pipe 23 transporting the collected mixture opening out into its bottom end, and itself opening out into the tank 11 under its opening 16.

The mixture leaving the pipe 23 then flows in the passage 65 in which its speed and pressure can decrease, and where the phases can separate, until it reaches the top outlet from the passage 65 where the phases of the mixture flow into the cavities 70 and 71 as defined respectively by the tanks 11 and 12.

In the embodiment of FIGS. 5 and 6, the tanks 11 and 12 and the pipes 21 to 23 are bodies of revolution about the axis 30, the pipes 21 to 23 extending along this common axis, with the pipe 21 extending inside the pipe 22.

In all embodiments, the phases of the fluid/mixture leaving the pipe/passage 23, 65, 234 are separated in particular by gravity inside the cavity 70 defined by the tank 11 and in the portion 71 of the cavity defined by the tank 12 that extends above the cavity 70.

The interface 72 between the two phases is substantially horizontal and normally extends inside the cavity 70 of the tank 11, while the interface 73 between the lighter phase present in the plenum of the tank 12 and the sea water surrounding the device normally extends in the peripheral cavity 50 between the respective walls of the tanks 11 and 12.

The separation of the phases of the mixture is enhanced in particular by the fact that the bottom end 210 of the pipe 21, through which the “heavy” phase collected in the tank 11 “escapes”, is situated under the top end 230 of the pipe/passage 23, 65, 234 through which the fluid is introduced into the cavities 70, 71, and at a significant distance from this end 230.

With reference to FIGS. 1 to 4 in particular, the device 10 has a fourth pipe 24 opening out into the second tank 12 and fitted with an isolation valve 80, and a third tank 13 connected to the tank 12 by the pipe 24 and containing a rinsing fluid under pressure for expelling the sea water contained in the device after it has been immersed.

With reference to FIG. 8, the device 10 has a fifth pipe 25 opening out into the second tank 12 and fitted with an isolation valve 800, and a fourth tank 130 connected to the tank 12 by the pipe 25 and containing an inhibitor fluid, for example methanol, for limiting or avoiding the formation of hydrates in the peripheral space 50.

The pipes 21 to 23 and the walls 14, 15, 17, and 18 of the first and second tanks may be made of a material that withstands corrosion by sea water, in particular a metal, or a plastics material, or an elastomer, and it may have a double wall suitable for being filled with sea water.

At least a portion of the peripheral wall 17 of the second tank may be provided with a thermal “barrier” in this way, or otherwise, which barrier limits the extent to which the fluids present in the cavity 50 are cooled by the sea water surrounding the second tank.

In contrast, a portion at least of the peripheral wall 14 of the first tank, in particular the portion of this wall that faces the interface 73, may be made of metal, by way of example, in order to form a thermal “bridge” for enhancing the heating of the fluids present in the cavity 50 by the fluid contained in the first tank.

With reference to FIGS. 1 to 4 in particular, the device 10 includes a shutter arranged in the vicinity of the inlet 220 to the second pipe 22.

The shutter comprises a ball-shaped movable member 81 of density that presents a value intermediate between the density of the first phase of the mixture and the density of the second phase of the mixture.

The shutter also has a guide 82 for the member 81, in particular a cage extending inside the tank 12 in line with the pipe 22 and in which the ball 81 can move.

Thus, the ball is held by gravity in the bottom portion of the guide 82 so long as it is not surrounded by a fluid of density greater than its own, and it can then allow the first phase contained in the plenum of the cavity 71 of the tank 12 to escape (cf. arrows 55) from the tank 12 via the pipe 22 to the surface of the sea.

In contrast, if the level of the first phase in the tank 12 reaches or exceeds the bottom end of the guide 82 supporting the bail 81, then the ball 81 floats on the first phase and can rise inside the cage 82 until it comes into contact with the end 220 of the pipe 22, thereby closing the pipe 22 and preventing the first phase, and indeed the second phase, from then penetrating into the pipe.

In other embodiments, an isolation valve, a shutter, and/or a flow rate control member for the transported fluid may also be fitted to the pipes 21 to 23, as shown in FIG. 8 for the segment of pipe 22.

With reference to FIGS. 2 to 4 in particular, in order to collect a mixture 200 of two phases of different densities, both less than that of sea water, and that is escaping from an undersea structure 20 in the vicinity of the sea bottom 90, it is possible to perform the following operations in succession:

immersing the device 10 in the proximity of the bottom 90 and the structure 20 and stabilizing the position of the collector device by anchoring it to the bottom 90 with the help of cables 91 and/or by establishing a mechanical connection between the device 10 and the structure 20, as shown in FIG. 2, such that the axis 30 is substantially vertical, the opening 16 extends in a plane that is substantially horizontal at the top portion of the tank 11, and the opening 19 extends in a plane that is substantially horizontal at the bottom portion of the tank 12; then

opening the valve 80 in order to introduce the rinsing fluid contained in the tank 13 into the tanks 11 and 12 so as to discharge at least the major portion of the sea water held “captive” in the tanks 11 and 12 during immersion of the device, as shown in FIG. 3; and then

connecting the bottom end 230 of the pipe 23 to the structure 20 in as leaktight a manner as possible.

The procedure is similar when using a collector device of the kind shown in FIGS. 5 and 8 in which the collector structure 92 comprises a deployable diaphragm: the collector structure is initially positioned over the point where the fluid for collection is immersing, is then deployed downwards surrounding the zone or the structure from which the fluid for collecting is escaping, substantially down to the sea bottom 90, on which the base of the structure may rest by means of bags 93 filled with a composition of greater density than sea water, e.g. filled with sand.

This leads to the jet 200 of mixture being introduced into the cavities 70, 71, and 50 of the device that are in communication with the undersea medium so that the cavities are maintained in pressure equilibrium with that medium.

The above-described configuration for the tanks 11, 12 and the pipes 21 to 23 in particular, then encourages the phases contained in the mixture to separate, with the “heavier” phase flowing into the first tank and the “lighter” phase flowing in the second tank.

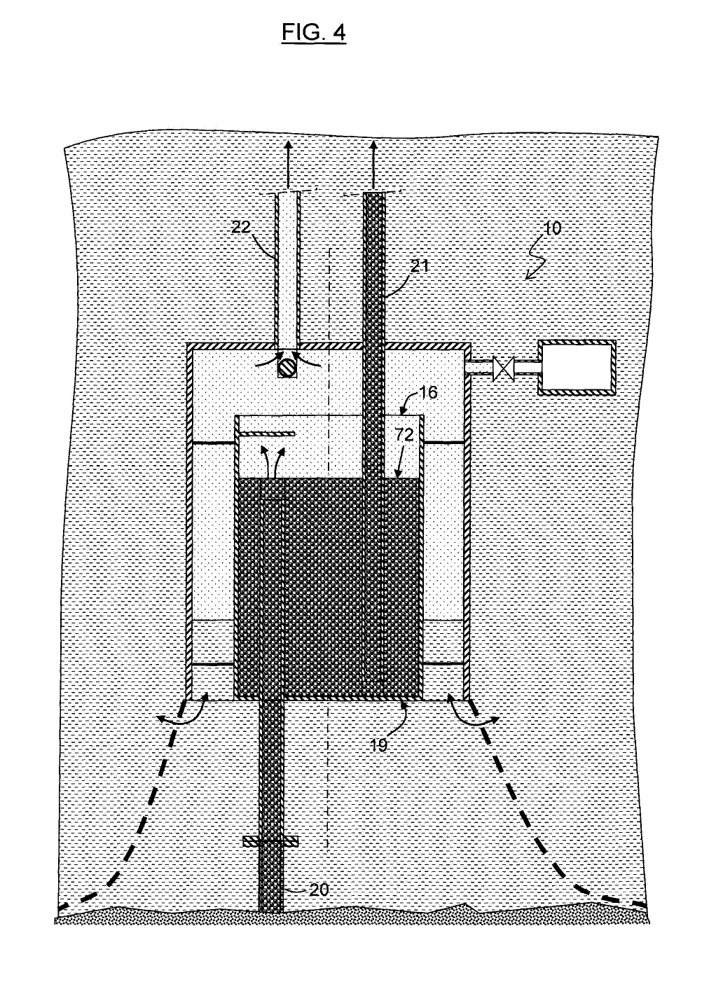

It is thus possible to recover the heavy phase flowing as a result of density difference in the first pipe 21 and also the light phase likewise flowing by density difference in the second pipe 22, as shown in FIG. 4.

Under steady operating conditions for the collector device, the interface 72 becomes established between the position measured along the axis 30 of the opening 16 and the position of the end 210 of the pipe 21, while the interface 73 becomes established at a position intermediate between the position of the opening 16 and the position of the opening 19.

The height, i.e. the length measured along the axis 30, between the opening 16 of the vessel 11 and the bottom opening 210 of the pipe 21 determines the maximum variation possible for the level of the interface 72 between the two separated phases: if this interface rises above the opening 16, then the heavy phase can pour out from the tank 11 into the space 50 defined by the walls of the tanks 11 and 12, and possibly to the outside of the tank 12 and of the device 10.

Together with the diameter or the equivalent diameter of the wall 14 of the tank 11, this height determines the working capacity of the tank.

Furthermore, if the interface 72 moves down below the opening 210 of the pipe 21, the pipe can cease to be primed and the gravity upflow of the heavy phase in the pipe 21 can be interrupted.

In similar manner, the height measured along the axis 30 between the respective openings 16 and 19 of the vessels 11 and 12 determines the maximum variation in the level of the interface 73 between the light phase and sea water in the peripheral space 50: if this interface rises above the opening 16, sea water can then pour into the inside of the tank 11, whereas if this interface 73 drops below the opening 19 of the tank 12, the phase(s) of the mixture contained in the space 50 can escape to the outside of the tank 12 via the opening 19.

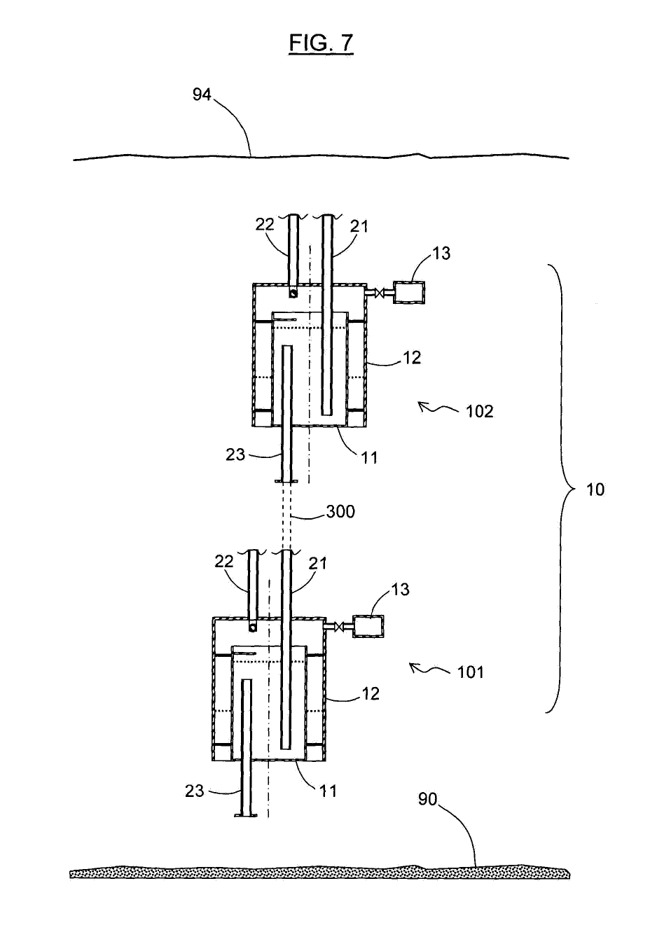

With reference to FIG. 7, the device has two phase separation modules 101 and 102 with a pipe 300 connecting the modules together.

Each of the modules 101 and 102 is identical to the collector and separation device shown in FIGS. 1 to 4; in other embodiments that are not shown, at least one of these two modules could be identical or similar to the device shown in FIGS. 5 and 6, or may present other shapes and configurations.

In FIG. 7, it can be seen that the pipe 300 connects the outlet from the pipe 21 of the lower module 101 that is used for transporting the heavy phase delivered by that module to the inlet pipe 23 of the upper module 102.

This modular device thus makes it possible to perform two phase separations in succession: a first separation of the collected mixture in the first module 101, and a second separation of a plurality of phases transported by the pipe 21 of the module 101 in the second module 102.

1. A device (10, 101, 102) for undersea collection of a fluid (200) of density lower than that of sea water, the device being characterized in that it comprises:
a first tank (11) for receiving the fluid, which tank is provided with a first opening (16) and a second opening (233);
a second tank (12) covering the first opening (16), surrounding a portion of the first tank, and provided with a third opening (19) putting the second tank into communication with a medium surrounding the device;
connection means (58) for connecting together the first and second tanks;
a first pipe (21) opening out into the first tank (11) in order to provide density transport (57) of at least a first phase of the fluid to the surface (94);
a guiding structure (64, 234) for guiding the fluid and introducing (53) the fluid into the first tank (11), which structure extends inside the first tank (11) and separates a first portion of the first tank in which the second opening (233) is provided from a second portion of the first tank in which the open end (210) of the first pipe (21) extends; and
a collecting structure (92, 235) for collecting the fluid, which structure extends outside the first tank (11), is secured to the first tank, and surrounds the second opening (233).

2. A device according to claim 1, comprising a second pipe (22) opening out into the second tank (12) for density transport (56) of at least one second phase of the fluid to the surface.

3. A device according to claim 1, wherein the collecting structure (92, 235) is flexible or deployable so as to pass from a gathered configuration adapted to moving the device and putting it into place under water, to a deployed configuration adapted to collecting the fluid.

4. A device according to claim 2, comprising a third pipe (23) comprising said guiding structure (234) and said collecting structure (92, 235), and wherein a free end (230) of the third pipe (23) is fitted with a connection device (231) suitable for connecting to a structure (20) from which the fluid (200) for collecting is escaping.

5. A device according to claim 4, comprising a fourth pipe (24) opening out into the second tank (12) and fitted with a sectioning or closing member (80), which pipe serves to introduce a rinsing fluid for discharging the sea water contained in the device.

6. A device according to claim 5, comprising a third tank (13) for storing the rinsing fluid under pressure, which third tank is connected to the second tank (12) by the fourth pipe (24).

7. A device according to claim 1, wherein at least a portion of the wall of the second tank (12), in particular the portion of said wall that extends around the first tank (11), includes thermal insulation so as to limit the cooling of the phases of the fluid by sea water surrounding the device (10).

8. A device according to claim 2, wherein at least one of the first and the second pipe(s) (21, 22) is provided with thermal insulation.

9. A device according to claim 1, wherein at least one of the first and second tanks (11, 12) comprises a structure (14, 15, 17, 18) that is flexible or deployable, suitable for being made of plastics material or of elastomer, and in particular a structure that is inflatable and that has a double wall.

10. A device according to claim 1, wherein the first and second tanks (11, 12), which are, at least in part, contained one within the other, extend along a common axis (30), and in particular present shapes that are substantially bodies of revolution having respective axes of revolution (30) that substantially coincide.

11. A device according to claim 4, wherein at least one of said first, second, and third pipe(s) (21, 22, 23) is fitted with at least one sectioning or closure member (81, 82) such as a valve or a ball shutter (81), and/or a flow rate control member.

12. A device according to claim 2, comprising a shutter arranged in the vicinity of the inlet (220) of the second pipe (22), the shutter having a movable member (81) of density presenting a value intermediate between the density of the first phase of the fluid and the density of the second phase of the fluid, such that the movable member (81) can float on the first phase and prevent the first phase being introduced into the second pipe.

13. A device according to claim 1, comprising means (91) for positioning the tanks (11, 12) in order to maintain the first and second tanks close to a place or a structure (20) from which the fluid for collection is escaping, such as cables fastened to the sea bottom by anchors or by deadweights resting on the sea bottom.

14. A device according to claim 2, comprising phase separator means, in particular deflector or separator walls (60, 64) that are arranged in the first tank in order to enhance mutual separation between first and second phases of the fluid inside the first and second tanks so as to avoid or limit any passage of the second phase into the first pipe, and to avoid or limit any passage of the first phase into the second pipe.

15. A device for collecting a light undersea fluid (200), which device comprises at least two modules or devices (10, 101, 102) according to claim 1, each module serving to separate fluid phases in pressure equilibrium with the surrounding undersea medium, the modules being connected together by at least one riser column (300).

16. A method of collecting an undersea fluid (200) comprising at least a first phase of density less than the density of sea water, and at least one second phase of density less than that of sea water and less than that of the first phase, the method comprising the steps of:
causing the fluid to be introduced (53) into a cavity (50, 70, 71) communicating with the undersea medium in such a manner that the cavity is maintained in pressure equilibrium with the medium, the cavity being defined by two tanks: i) a first tank (11) comprising a first opening (16) and a second opening (233); and ii) a second tank (12) covering the first opening, surrounding at least a portion of the first tank, connected to the first tank and in communication therewith, and provided with a third opening (19) in communication with the undersea medium; by: i) collecting the fluid into a collecting structure (92, 235) that extends outside the first tank (11), that is secured to the first tank, and that surrounds the second opening (233): ii) and guiding the fluid by means of a guiding structure (234) that extends inside the first tank (11) and that separates a first portion of the first tank in which the second opening (233) is provided from a second portion of the first tank into which there opens out the open end (210) of a first pipe (21) opening out into the first tank (11): and iii) enhancing the flow of the first phase in the first tank, and enhancing separation of the phases in the cavity and the flow of the second phase in the second tank; and
recovering the first phase rising by density difference in the first pipe (21), and recovering the second phase by density difference in a second pipe (22) opening out into the second tank (12).

17. A method according to claim 16, comprising the following operations:
immersing a collector device (10) in the proximity of a jet or a source (200) of fluid to be collected;
stably positioning the collector device (10) relative to a structure (20) from which the fluid for collection is escaping by anchoring it to the bottom (90) and/or by establishing mechanical connections between the collector device and the structure (20);
introducing a rinsing fluid in the first and second tanks (11, 12) in order to discharge the sea water; and
deploying the collecting structure (92, 235) around the structure (20) from which the fluid for collection is escaping.

18. A method according to claim 17, wherein a rinsing fluid in liquid or gaseous form is used that is of density less than the density of the lowest density phase of the fluid to be collected.

19. A method according to claim 16, wherein the collected fluid is constituted essentially by a liquid hydrocarbon, a mixture of liquid and gaseous hydrocarbons, or a mixture of gaseous hydrocarbon(s) and a mud comprising one or more liquid hydrocarbons mixed with hydrates.

20. A method according to claim 16, wherein the collected fluid is constituted essentially by fresh water mixed with, or containing, one or more gases.

21. A method according to claim 16, wherein use is made of a device (10, 101, 102) comprising:
a first tank (11) for receiving the fluid, which tank is provided with a first opening (16) and a second opening (233);
a second tank (12) covering the first opening (16), surrounding a portion of the first tank, and provided with a third opening (19) putting the second tank into communication with a medium surrounding the device;
connection means (58) for connecting together the first and second tanks;
a first pipe (21) opening out into the first tank (11) in order to provide delivery transport (57) of at least a first phase of the fluid to the surface (94);
a guiding structure (64, 234) for guiding the fluid and introducing (53) the fluid into the first tank (11), which structure extends inside the first tank (11) and separates a first portion of the first tank in which the second opening (233) is provided from a second portion of the first tank in which the open end (210) of the first pipe (21) extends; and
a collecting structure (92, 235) for collecting the fluid, which structure extends outside the first tank (11), is secured to the first tank, and surrounds the second opening (233).
